(19) United States
(12) Patent Application Publication
(10) Pub. No.: US 2017/0247271 A1
(43) Pub. Date: Aug. 31, 2017

(54) IMPROVED PROCESS FOR TREATING AQUEOUS MINERAL SUSPENSIONS

(71) Applicant: Dow Global Technologies LLC, Midland, MI (US)

(72) Inventors: Paul A. Gillis, Lake Jackson, TX (US); Jason S. Moore, Walnut Creek, CA (US); Billy G. Smith, Brazoria, TX (US); Michael D. Cloeter, Lake Jackson, TX (US); Michael K. Poindexter, Sugar Land, TX (US); Carol E. Mohler, Midland, MI (US); Wu Chen, Lake Jackson, TX (US); Cole A. Witham, Pearland, TX (US); Justice Alaboson, Lake Jackson, TX (US); Shankhadeep Das, Houston, TX (US); Harpreet Singh, Pearland, TX (US)

(73) Assignee: Dow Global Technologies LLC, Midland, MI (US)

(21) Appl. No.: 15/328,549

(22) PCT Filed: Jul. 31, 2015
(86) PCT No.: PCT/US15/43044

§ 371 Date: Jan. 24, 2017

Related U.S. Application Data
(60) Provisional application No. 62/135,891, filed on Mar. 20, 2015.
(60) Provisional application No. 62/031,365, filed on Jul. 31, 2014.

(51) Int. Cl. C02F 1/56; C02F 11/16; C10G 1/04; B01F 7/22; B01F 7/00; C02F 11/14; C02F 11/12

(52) U.S. Cl. CPC C02F 1/56; C02F 11/14; C02F 11/16; C02F 11/127; B01F 7/22; B01F 7/00341; B01F 7/0035; B01F 7/00633; B01F 7/00908; C10G 1/047; C02F 2103/10

(57) ABSTRACT

The present invention relates to a method for flocculating and dewatering oil sands fine tailings. Said method comprises mixing the aqueous mineral suspension with a poly(ethylene oxide) (co)polymer to form a dough-like material. The material is then dynamically mixed in an in-line reactor to break down the dough-like material to form microflocs having an average size of 1 to 500 microns, and to release water. The internal diameter of the in-line reactor is at most five times the internal diameter of the inlet pipe of the reactor. The suspension of microflocs has a viscosity of at most 1000 cP and a yield stress of at most 300 Pa.

### FIELD OF THE INVENTION

The present invention relates to an in-line dynamic mixing apparatus and process for treating aqueous mineral suspensions, especially waste mineral slurries, using a polymeric flocculant composition, preferably comprising a poly(ethylene oxide) homo- or copolymer. The process of the present invention is particularly suitable for the treatment of tailings and other waste material resulting from mineral processing, in particular, processing of oil sands tailings.

### BACKGROUND OF THE INVENTION

Fluid tailings streams derived from mining operations, such as oil sands mining operations, are typically composed of water and solid particles. In order to recover the water and consolidate the solids, solid/liquid separation techniques must be applied. In oil sands processing a typical fresh tailings stream comprises water, sand, silt, clay and residual bitumen. Oil sands tailings typically comprise a substantial amount of fine particles (which are defined as solids that are less than 44 microns).

The bitumen extraction process utilizes hot water and chemical additives such as sodium hydroxide or sodium citrate to remove the bitumen from the ore body. The side effect of these chemical additives is that they can change the inherent water chemistry. The inorganic solids as well as the residual bitumen in the aqueous phase acquire a negative charge. Due to strong electrostatic repulsion, the fine particles form a stabilized suspension that does not readily settle by gravity, even after a considerable amount of time. In fact, if the suspension is left alone for 3-5 years, a gel-like layer known as mature fine tailings (MFT) will be formed and this type of tailings is very difficult to consolidate even with current technologies.

Recent methods for dewatering MFT are disclosed in WO 2011/032258 and WO 2001/032253, which describe in-line addition of a flocculant solution, such as a polyacrylamide (PAM), into the flow of oil sands tailings, through a conduit such as a pipeline. Once the flocculant is dispersed into the oil sands tailings, the flocculant and tailings continue to mix as they travel through the pipeline and the dispersed fine clays, silt, and sand bind together (flocculate) to form larger structures (flocs) that can be separated from the water when ultimately deposited in a deposition area. However, the degree of mixing and shearing is dependent upon the flow rate of the materials through the pipeline as well as the length of the pipeline. Thus, any changes in the fluid properties or flow rate of the oil sands fine tailings may have an effect on both mixing and shearing and ultimately flocculation. Thus, if one has a length of open pipe, it would be difficult to control flocculation because of the difficulty in independently controlling both the shear rate and residence time simply by changing the flow rate.

CA Patent Application No. 2,512,324 suggests addition of water-soluble polymers to oil sands fine tailings during the transfer of the tailings as a fluid to a deposition area, for example, while the tailings are being transferred through a pipeline or conduit to a deposition site. However, once again, proper mixing of polymer flocculant with tailings is difficult to control due to changes in the flow rate and fluid properties of the tailings material through the pipeline.

U.S. Publication No. 2013/0075340 discloses a process for flocculating and dewatering oil sands tailings comprising adding oil sands tailings as an aqueous slurry to a stirred tank reactor; adding an effective amount of a polymeric flocculant, such as charged or uncharged polyacrylamides, to the stirred tank reactor containing the oil sands tailings, dynamically mixing the flocculant and oil sands tailings for a period of time sufficient to form a gel-like structure; subjecting the gel-like structure to shear conditions in the stirred tank reactor for a period of time sufficient to break down the gel-like structure to form flocs and release water; and removing the flocculated oil sands fine tailings from the stirred tank reactor when the maximum yield stress of the flocculated oil sands fine tailings begins to decline but before the capillary suction time of the flocculated oil sands fine tailings begins to substantially increase from its lowest point.

While polyacrylamides are generally useful for fast consolidation of tailings solids, they are highly dose sensitive towards the flocculation of fine particles and it is challenging to find conditions under which a large proportion of the fine particles are flocculated. As a result, the water recovered from a PAM consolidation process is often of poor quality and may not be good enough for recycling because of high fines content in the water. Additionally, tailings treated with PAM are shear sensitive so transportation of treated thickened tailings to a dedicated disposal area (DDA) and general materials handling can become a further challenge.

Alternatively, polyethylene oxide (PEO) is known as a flocculant for mine tailings capable of producing a lower turbidity supernatant as compared to PAM, for example see U.S. Pat. No. 4,931,190; U.S. Pat. No. 5,104,551; U.S. Pat. No. 6,383,282; WO 2011070218; Sharma, S. K., Scheiner, B. J., and Smelley, A. G., (1992). Dewatering of Alaska Pacer Effluent Using PEO. United States Department of the Interior, Bureau of Mines, Report of Investigation 9442; and Sworska, A., Laskowski, J. S., and Cymerman, G. (2000). Flocculation of the Syncrude Fine Tailings Part II. Effect of Hydrodynamic Conditions. Int. J. Miner. Process., 60, pp. 153-161. However, PEO polymers have not found widespread commercial use in oil sand tailing treatment because of mixing and processing challenges resulting from its high viscosities with clay-based slurries.

In spite of the numerous processes and polymeric flocculating agents used therein, there is still a need for a flocculating process to further improve the settling and consolidation of suspensions of materials as well as further improve upon the dewatering of suspensions of waste solids that have been transferred as a fluid or slurry to a settling area for disposal. In particular, it would be desirable to provide a more effective treatment of waste suspensions, such as oil sands tailings, transferred to disposal areas ensuring improved concentration of solids and improved clarity of released water with improved shear stability and wider dose tolerance.

### BRIEF SUMMARY OF THE INVENTION

The present invention is a process for flocculating and dewatering oil sands fine tailings, comprising the steps: i) providing an in-line flow of an aqueous suspension of oil sands fine tailings through a pipe, said pipe having an internal diameter, ii) introducing a flocculant composition comprising a poly(ethylene oxide) (co)polymer, preferably a poly(ethylene oxide) homopolymer, a poly(ethylene oxide) copolymer, or mixtures thereof, into the aqueous suspension of oil sands fine tailings, iii) mixing the flocculant composition and the aqueous suspension of oil sands fine tailings without static or dynamic mixers, e.g., no moving parts such as a rotating impeller to aid mixing, energy input for a period of time sufficient to form a dough-like material, iv) introducing the dough-like material into an in-line reactor through the pipe wherein the internal diameter of the in-line reactor is equal to or less than five times the internal diameter of the pipe, v) subjecting the dough-like material to dynamic mixing within the in-line reactor for a period of time sufficient to break down the dough-like material to form microflocs and release water, wherein the resulting flocculated oil sands tailings has a viscosity equal to or less than 1,000 cP and a yield stress of equal to or less than 300 Pa, and said microflocs have an average size of from 1 to 500 microns, vi) flowing the flocculated oil sands fine tailings from the in-line reactor through a pipe or one or more static mixer or a combination of piping and one or more static mixer, and vii) further treating or depositing the flocculated oil sands fine tailings.

One embodiment of the process of the present invention described herein above further comprises the step: viii) adding the flocculated oil sands fine tailings to at least one centrifuge to dewater the flocculated oil sands fine tailings and form a high solids cake and a low solids centrate.

Another embodiment of the process of the present invention described herein above further comprises the step: viii) adding the flocculated oil sands fine tailings to a thickener to dewater the flocculated oil sands fine tailings and produce thickened oil sands fine tailings and clarified water.

Another embodiment of the process of the present invention described herein above further comprises the step: viii) adding the flocculated oil sands fine tailings to at least one deposition cell such as an accelerated dewatering cell for dewatering.

Another embodiment of the process of the present invention described herein above further comprises the step: viii) spreading the flocculated oil sands fine tailings as a thin layer onto a sloped deposition site.

In one embodiment of the process of the present invention disclosed herein above, the poly(ethylene oxide) copolymer is a copolymer of ethylene oxide with one or more of epichlorohydrin, propylene oxide, butylene oxide, styrene oxide, an epoxy functionalized hydrophobic monomer, glycidyl ether functionalized hydrophobic monomer, a silane-functionalized glycidyl ether monomer, or a siloxane-functionalized glycidyl ether monomer.

In one embodiment of the process of the present invention disclosed herein above, the poly(ethylene oxide) (co)polymer has a molecular weight of equal to or greater than 1,000,000 Da.

In one embodiment of the process of the present invention disclosed herein above, the flow of oil sands tailings treated with the poly(ethylene oxide) (co)polymer is laminar throughout the treatment process and/or is transported to the deposition area in the laminar flow regime.

In one embodiment of the process of the present invention disclosed herein above, the oil sands fine tailings are mature fines tailings (MFT).

In one embodiment of the process of the present invention disclosed herein above, the oil sands fine tailings are thickened tailings (TT).

### BRIEF DESCRIPTION OF THE DRAWINGS

FIG. 1 is a schematic of embodiments A to D of the process of the present invention.

FIG. 2 is a schematic plain view of a dynamic mixer apparatus of the process of the present invention for dynamically mixing a flocculant with an aqueous suspension of oil sands fine tailing.

FIG. 3 shows two different rotor designs for the dynamic mixer apparatus of the present invention.

FIG. 4 shows two different stator designs for the dynamic mixer apparatus of the present invention.

FIG. 5 is a copy of a photograph of microflocs generated by the process of the present invention.

FIG. 6 is a plot of viscosity versus time for Example 1 and Comparative Example A.

FIG. 7 is a graph showing the settling curve for Example 19 wherein mature fine tailings are treated by the process of the present invention.

FIG. 8 are settling images for Example 22 versus time.

FIG. 9 shows the settling curves for Examples 20 to 22 wherein thickened tailings are treated by the process of the present invention.

FIG. 10 shows images for lack of settling for Comparative Examples B to D.

### DETAILED DESCRIPTION OF THE INVENTION

According to the present invention, we provide a process for dewatering an aqueous mineral suspension comprising introducing into the suspension a flocculating composition comprising a poly(ethylene oxide) homopolymer, a poly(ethylene oxide) copolymer, or mixtures thereof, herein after collectively referred to as “poly(ethylene oxide) (co)polymer”. Typically, the material to be flocculated may be derived from or contain filter cake, tailings, thickener underflows, or unthickened plant waste streams, for instance other mineral tailings, slurries, or slimes, including phosphate, diamond, gold slimes, mineral sands, tails from zinc, lead, copper, silver, uranium, nickel, iron ore processing, coal, oil sands or red mud. The material may be solids settled from the final thickener or wash stage of a mineral processing operation. Thus the material desirably results from a mineral processing operation. Preferably the material comprises tailings. Preferably the mineral material would be selected from red mud and tailings containing clay, such as oil sands tailings, etc.

The oil sands tailings or other mineral suspensions may have a solids content in the range 5 percent to 80 percent by weight. The slurries or suspensions often have a solids content in the range of 10 percent to 70 percent by weight, for instance 25 percent to 40 percent by weight. The sizes of particles in a typical sample of the fine tailings are substantially all less than 45 microns, for instance about 95 percent by weight of material is particles less than 20 microns and about 75 percent is less than 10 microns. The coarse tailings are substantially greater than 45 microns, for instance about 85 percent is greater than 100 microns but generally less than 10,000 microns. The fine tailings and coarse tailings may be present or combined together in any convenient ratio provided that the material remains pumpable.

The dispersed particulate solids may have a unimodal, bimodal, or multimodal distribution of particle sizes. The distribution will generally have a fine fraction and a coarse fraction, in which the fine fraction peak is substantially less than 44 microns and the coarse (or non-fine) fraction peak is substantially greater than 44 microns.

The flocculant composition of the process of the present invention comprises a polymeric flocculant, preferably poly(ethylene oxide) homopolymer, a poly(ethylene oxide) copolymer, or mixtures thereof. Poly(ethylene)oxide (co)polymers and methods to make said polymers are known, for example see WO 2013116027. In one embodiment of the present invention, a zinc catalyst, such as disclosed in U.S. Pat. No. 4,667,013, can be employed to make the poly(ethylene oxide) (co)polymers of the present invention. In a preferred embodiment the catalyst used to make the poly(ethylene oxide) (co)polymers of the present invention is a calcium catalyst such as those disclosed in U.S. Pat. No. 2,969,402; U.S. Pat. No. 3,037,943; U.S. Pat. No. 3,627,702; U.S. Pat. No. 4,193,892; and U.S. Pat. No. 4,267,309, all of which are incorporated by reference herein in their entirety. A preferred zinc catalyst is a zinc alkoxide catalyst as disclosed in U.S. Pat. No. 6,979,722, which is incorporated by reference herein in its entirety.

A preferred alkaline earth metal catalyst is referred to as a “modified alkaline earth hexammine” or a “modified alkaline earth hexammoniate” the technical terms “ammine” and “ammoniate” being synonymous. A modified alkaline earth hexammine useful for producing the poly(ethylene oxide) (co)polymer of the present invention is prepared by admixing at least one alkaline earth metal, preferably calcium metal, strontium metal, or barium metal, zinc metal, or mixtures thereof, most preferably calcium metal; liquid ammonia; an alkylene oxide; which is optionally substituted by aromatic radicals, and an organic nitrile having at least one acidic hydrogen atom to prepare a slurry of modified alkaline earth hexammine in liquid ammonia; continuously transferring the slurry of modified alkaline earth hexammine in liquid ammonia into a stripper vessel and continuously evaporating ammonia, thereby accumulating the modified catalyst in the stripper vessel; and upon complete transfer of the slurry of modified alkaline earth hexammine into the stripper vessel, aging the modified catalyst to obtain the final polymerization catalyst. In a preferred embodiment of the alkaline earth metal catalyst of the present invention described herein above, the alkylene oxide is propylene oxide and the organic nitrile is acetonitrile.

A catalytically active amount of alkaline earth metal catalyst is used in the process to make the poly(ethylene oxide) (co)polymer of the present invention, preferably the catalysts is used in an amount of from 0.0004 to 0.0040 g of alkaline earth metal per gram of epoxide monomers (combined weight of all monomers, e.g., ethylene oxide and silane- or siloxane-functionalized glycidyl ether monomers), preferably 0.0007 to 0.0021 g of alkaline earth metal per gram of epoxide monomers, more preferably 0.0010 to 0.0017 g of alkaline earth metal per gram of epoxide monomers, and most preferably 0.0012 to 0.0015 g of alkaline earth metal per gram of epoxide monomer.

The catalysts may be used in dry or slurry form in a conventional process for polymerizing an epoxide, typically in a suspension polymerization process. The catalyst can be used in a concentration in the range of 0.02 to 10 percent by weight, such as 0.1 to 3 percent by weight, based on the weight of the epoxide monomers feed.

The polymerization reaction can be conducted over a wide temperature range. Polymerization temperatures can be in the range of from −30° C. to 150° C. and depends on various factors, such as the nature of the epoxide monomer(s) employed, the particular catalyst employed, and the concentration of the catalyst. A typical temperature range is from 0° C. to 150° C.)

The pressure conditions are not specifically restricted and the pressure is set by the boiling points of the diluent and comonomers used in the polymerization process.

In general, the reaction time will vary depending on the operative temperature, the nature of the comonomer(s) employed, the particular catalyst and the concentration employed, the use of an inert diluent, and other factors. As defined herein copolymer may comprise more than one comonomer, for instance there can be two comonomers, three comonomers, four comonomers, five comonomers, and so on. Suitable comonomers include, but are not limited to, epichlorohydrin, propylene oxide, butylene oxide, styrene oxide, an epoxy functionalized hydrophobic monomer, a glycidyl ether or glycidyl propyl functionalized hydrophobic monomer, a silane-functionalized glycidyl ether or glycidyl propyl monomer, a siloxane-functionalized glycidyl ether or glycidyl propyl monomer, an amine or quaternary amine functionalized glycidyl ether or glycidyl propyl monomer, and a glycidyl ether or glycidyl propyl functionalized fluorinated hydrocarbon containing monomer. Specific comonomers include but are not limited to 2-ethylhexylglycidyl ether, benzyl glycidyl ether, nonylphenyl glycidyl ether, 1,2-epoxydecane, 1,2-epoxyoctane, 1,2-epoxytetradecane, glycidyl 2,2,3,3,4,4,5,5-octafluoropentyl ether, glycidyl 2,2,3,3-tetrafluoropropyl ether, octylglycidyl ether, decylglycidyl ether, 4-chlorophenyl glycidyl ether, 1-(2,3-epoxypropyl)-2-nitroimidazole, 3-glycidylpropyl triethoxysilane, 3-glycidoxypropyldimethylethoxysilane, diethoxy(3-glycidyloxypropyl) methylsilane, poly(dimethylsiloxane) monoglycidylether terminated, and (3-glycidylpropyl)trimethoxysilane. Polymerization times can be run from minutes to days depending on the conditions used. Preferred times are 1 h to 10 h.

The ethylene oxide may be present in an amount equal to or greater than 2 weight percent, preferably equal to or greater than 5 weight percent, and more preferably in an amount equal to or greater than 10 weight percent based on the total weight of said copolymer. The ethylene oxide may be present in an amount equal to or less than 98 weight percent, preferably equal to or less than 95 weight percent, and more preferably in an amount equal to or less than 90 weight percent based on the total weight of said copolymer.

The one or more comonomer may be present in an amount equal to or greater than 2 weight percent, preferably equal to or greater than 5 weight percent, and more preferably in an amount equal to or greater than 10 weight percent based on the total weight of said copolymer. The one or more comonomer may be present in an amount equal to or less than 98 weight percent, preferably equal to or less than 95 weight percent, and more preferably in an amount equal to or less than 90 weight percent based on the total weight of said copolymer. If two or more comonomers are used, the combined weight percent of the two or more comonomers is from 2 to 98 weight percent based on the total weight of said poly(ethylene oxide) copolymer.

The copolymerization reaction preferably takes place in the liquid phase. Typically, the polymerization reaction is conducted under an inert atmosphere, e.g., nitrogen. It is also highly desirable to affect the polymerization process under substantially anhydrous conditions. Impurities such as water, aldehyde, carbon dioxide, and oxygen which may be present in the epoxide feed and/or reaction equipment should be avoided. The poly(ethylene oxide) copolymers of this invention can be prepared via the bulk polymerization, suspension polymerization, or the solution polymerization route, suspension polymerization being preferred.

The copolymerization reaction can be carried out in the presence of an inert organic diluent such as, for example, aromatic hydrocarbons, benzene, toluene, xylene, ethylbenzene, and chlorobenzene; various oxygenated organic compounds such as anisole, the dimethyl and diethyl ethers of ethylene glycol, of propylene glycol, and of diethylene glycol; normally-liquid saturated hydrocarbons including the open chain, cyclic, and alkyl-substituted cyclic saturated hydrocarbons such as pentane (e.g. isopentane), hexane, heptane, various normally-liquid petroleum hydrocarbon fractions, cyclohexane, the alkylcyclohexanes, and decahydronaphthalene.

Unreacted monomeric reagent oftentimes can be recovered from the reaction product by conventional techniques such as by heating said reaction product under reduced pressure. In one embodiment of the process of the present invention, the poly(ethylene oxide) copolymer product can be recovered from the reaction product by washing said reaction product with an inert, normally-liquid organic diluent, and subsequently drying same under reduced pressure at slightly elevated temperatures.

In another embodiment, the reaction product is dissolved in a first inert organic solvent, followed by the addition of a second inert organic solvent which is miscible with the first solvent, but which is a non-solvent for the poly(ethylene oxide) copolymer product, thus precipitating the copolymer product. Recovery of the precipitated copolymer can be effected by filtration, decantation, etc., followed by drying same as indicated previously. Poly(ethylene oxide) copolymers will have different particle size distributions depending on the processing conditions. The poly(ethylene oxide) copolymer can be recovered from the reaction product by filtration, decantation, etc., followed by drying said granular poly(ethylene oxide) copolymer under reduced pressure at slightly elevated temperatures, e.g., 30° C. to 40° C. If desired, the granular poly(ethylene oxide) copolymer, prior to the drying step, can be washed with an inert, normally-liquid organic diluent in which the granular polymer is insoluble, e.g., pentane, hexane, heptane, cyclohexane, and then dried as illustrated above.

Unlike the granular poly(ethylene oxide) copolymer which results from the suspension polymerization route as illustrated herein above, a bulk or solution copolymerization of ethylene oxide with one or more comonomer yields a non-granular resinous poly(ethylene oxide) copolymer which is substantially an entire polymeric mass or an agglomerated polymeric mass or it is dissolved in the inert, organic diluent. It is understood, of course, that the term “bulk polymerization” refers to polymerization in the absence of an inert, normally-liquid organic diluent, and the term “solution polymerization” refers to polymerization in the presence of an inert, normally-liquid organic diluent in which the monomer employed and the polymer produced are soluble.

The individual components of the polymerization reaction, i.e., the epoxide monomers, the catalyst, and the diluent, if used, may be added to the polymerization system in any practicable sequence as the order of introduction is not crucial for the present invention.

The use of the alkaline earth metal catalyst described herein above in the polymerization of epoxide monomers allows for the preparation of exceptionally high molecular weight polymers. Without being bound by theory, it is believed that the unique capability of the alkaline earth metal catalyst to produce longer polymer chains than are otherwise obtained in the same polymerization system using the same raw materials with a non-alkaline earth metal catalyst is due to the combination of higher reactive site density (which is considered activity) and the ability to internally bind catalyst poisons.

Suitable poly(ethylene oxide) homopolymers and poly(ethylene oxide) copolymers useful in the method of the present invention have a weight average molecular weight equal to or greater than 100,000 daltons (Da) and equal to or less than 15,000,000 Da, preferably equal to or greater than 1,000,000 Da and equal to or less than 8,000,000 Da.

With the higher molecular weight polymers, viscosity measurements are challenging due to the difficulties encountered in dissolving the polymers in aqueous systems. During dissolution the mixture assumes a mucous-like consistency with a high tendency to gel. In some cases, extremely long chains are sensitive to shearing forces and must be stirred under very low shearing conditions in order to minimize mechanical degradation. The procedure for dissolving the polymers of the present invention may be found in Bulletin Form No. 326-00002-0303 AMS, published March 2003 by the Dow Chemical Company and entitled “POLYOX™ Water-Soluble Resins Dissolving Techniques”.

The term “1% aqueous solution viscosity” as used herein means the dynamic viscosity of a 1 weight % solution of the polymer in a mixture of water and isopropyl alcohol in a weight ratio of about 32:1. The weight percentage of polymer is based on the weight of water only, i.e., not including the isopropyl alcohol. When preparing the aqueous solutions of the polymers, the isopropyl alcohol is added first in order to allow the polymer particles to disperse before water is added. This minimizes gel formation and is critical to providing reliable viscosity measurements. The 1% aqueous solution viscosity of the ethylene oxide polymers according to the present invention is preferably greater than 1,200 mPas at 25° C. and less than 20,000 mPas at 25° C. The 1% aqueous solution viscosity of the ethylene oxide polymers is determined at 25° C. using a BROOKFIELD™ DV-II+digital viscometer. The BROOKFIELD guard leg is in place when making the measurement. RV spindle #2 and a speed of 2 RPM are employed to make the measurement. The spindle is immersed in the polymer solution, avoiding entrapping air bubbles, and attached to the viscometer shaft. The height is adjusted to allow the solution level to meet the notch on the spindle. The viscometer motor is activated, and the viscosity reading is taken 5 min after the viscometer motor is started.

Poly(ethylene oxide) (co)polymers are particularly suitable for use in the method of the present invention as flocculation agents for suspensions of particulate material, especially waste mineral slurries. Poly(ethylene oxide) (co)polymers are particularly suitable for the method of the present invention to treat tailings and other waste material resulting from mineral processing, in particular, processing of oil sands tailings.

Suitable amounts of the flocculant composition comprising the poly(ethylene oxide) (co)polymer to be added to the mineral suspensions range from 10 grams to 10,000 grams per ton of mineral solids. Generally the appropriate dose can vary according to the particular material and material solids content. Preferred doses are in the range 30 to 7,500 grams per ton, more preferably 100 to 3,000 grams per ton, while even more preferred doses are in the range of from 500 to 3,000 grams per ton. The flocculant composition comprising a poly(ethylene oxide) (co)polymer may be added to the suspension of particulate mineral material, e.g., the tailings slurry, in solid particulate form, an aqueous solution that has been prepared by dissolving the poly(ethylene oxide) (co)polymer into water, or an aqueous-based medium, or a suspended slurry in a solvent.

In the process of the present invention, the flocculant composition comprising a poly(ethylene oxide) (co)polymer may further comprise one or more other types of flocculant (e.g., polyacrylates, polymethacrylates, polyacrylamides, partially-hydrolyzed polyacrylamides, cationic derivatives of polyacrylamides, polydiallyldimethylammonium chloride (pDADMAC), copolymers of DADMAC, cellulosic materials, chitosan, sulfonated polystyrene, linear and branched polyethyleneimines, polyvinylamines, etc.) or other type of additive typical for flocculant compositions.

Coagulants, such as salts of calcium (e.g., gypsum, calcium oxide, and calcium hydroxide), aluminum (e.g., aluminum chloride, sodium aluminate, and aluminum sulfate), iron (e.g., ferric sulfate, ferrous sulfate, ferric chloride, and ferric chloride sulfate), magnesium carbonate, other multi-valent cations and pre-hydrolyzed inorganic coagulants, may also be used in conjunction with the poly(ethylene oxide) (co)polymer.

In one embodiment, the present invention relates to a process for dewatering oil sands tailings. As used herein, the term “tailings” means tailings derived from oil sands extraction operations and containing a fines fraction. The term is meant to include fluid fine tailings (FFT) and/or mature fine tailings (MFT) tailings and/or thickened tailings (TT) from ongoing extraction operations (for example, thickener underflow or froth treatment tailings) which may bypass a tailings pond and from tailings ponds. The oil sands tailings will generally have a solids content of 10 to 70 weight percent, or more generally from 25 to 40 weight percent, and may be diluted to 20 to 25 weight percent with water for use in the present process.

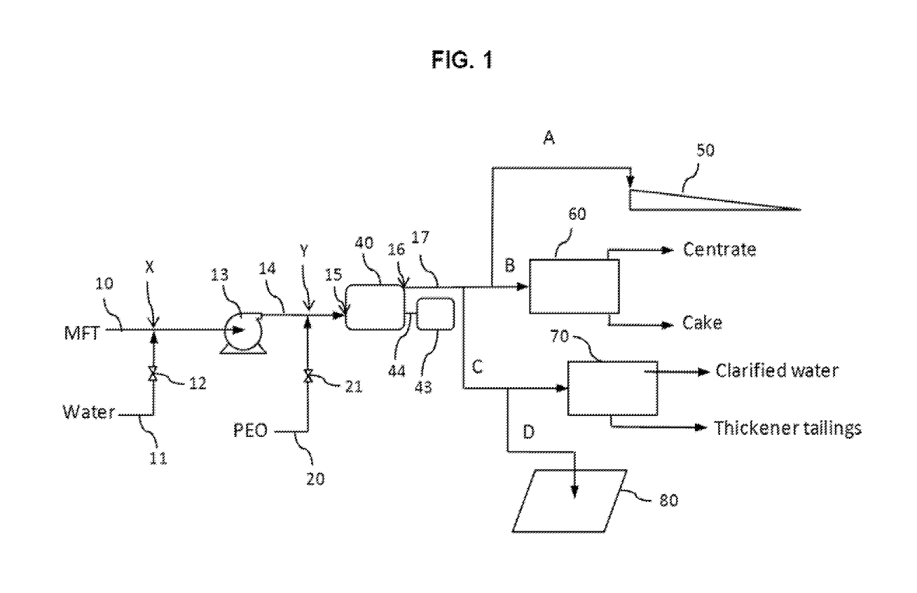

A schematic of four embodiments, A, B, C and D, of the present invention is shown in FIG. 1. The aqueous suspension containing solids such as oil sands mature fine tailings (MFT) in line 10 are pumped via pump 13 through a transportation conduit, preferably a first pipeline, line 14. If desired, additional water can be added to the MFT through line 11 at Point X. The flocculant composition comprising a poly(ethylene oxide) (co)polymer (referred herein after to as “PEO”) is added through line 20 at Point Y to the aqueous MFT suspension and the MFT and PEO are mixed in-line to form a dough-like mixture. To facilitate blending and interactions between the MFT and the PEO the combined stream can flow through a pipeline optionally containing a static mixing device, such as an in-line static mixer, or the like (not shown in the drawings) may be located in the first pipeline 14 after the addition point of the PEO Y and before the in-line pipeline reactor 40.

The dough-like mixture initially has a viscosity equal to or greater than double the viscosity of the initial mixture of MFT and PEO, preferably equal to or greater than three times the viscosity of the initial mixture of the MFT and PEO. Typically, the dough-like material has a viscosity equal to or greater than 4,000 cP, preferably equal to or greater than 6,000 cP, more preferably equal to or greater than 8, 000 cP, more preferably equal to or greater than 10,000 cP. Viscosity is conveniently determined using a Brookfield DV3T viscometer with a V73 spindle.

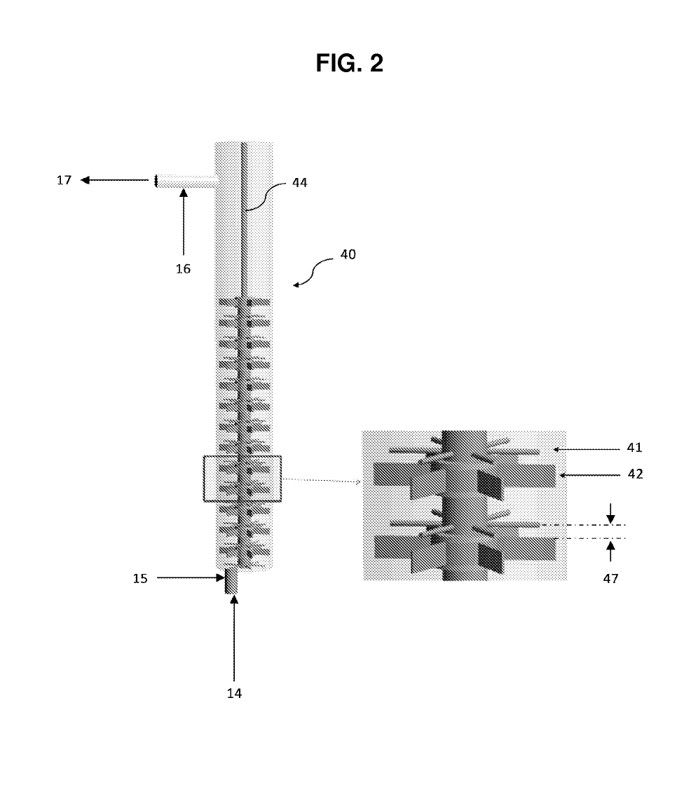

Generally, the flocculant composition comprising a poly(ethylene oxide) (co)polymer inlet and the MFT inlet are separated spatially. The dough-like mixture enters an in-line pipeline reactor 40. The pipeline reactor 40 comprises one or more rotor 41, preferably in combination with one or more stator 42, FIG. 2. Preferably, one or more rotor 41 and one or more stator 42 are arranged in an alternating fashion, i.e., rotor, stator, rotor, stator, etc. It is understood that the size, location and number of rotors and/or stators used in the in-line dynamic mixer 40 is dependent upon the overall dimensions (volume) of the dynamic mixer necessary for a particular operation.

The improvement in the process of the present invention involves the location and conditions under which the PEO is added to, and mixed with, the suspension containing solids, FIG. 1. The process of the present invention is conducted in a pipeline reactor 40 located within the pipeline comprising a first pipe 14 in which material enters the pipeline reactor 40 and a second pipe 17 in which material exits the pipeline reactor 40. Once material has exited the pipe line reactor 40 it may be further treated and/or deposited in a sloped deposition area. Generally, the line 14 which enters the pipeline reactor 40 is the same (i.e., the same diameter) as the line 17 which leaves the pipeline reactor 40, however the line 14 which enters the pipeline reactor 40 may have a larger diameter than line 17 which leaves the in-line reactor 40, or the line 14 which enters the pipeline reactor 40 may have a smaller diameter than line 17 which leaves the in-line reactor 40. Typical industrial tailings pipeline 14 diameters are in the range from 8 inches to 36 inches.

The special orientation, with regard to the ground, of the pipeline reactor 40 in the process of the present invention is not limited, it may be horizontal, vertical, or at any angle in between. Preferably the pipeline reactor 40 is in a vertical orientation wherein the dough-like mixture of MFT and PEO enters directly through line 14 at the bottom of the pipeline reactor 40 or optionally through the reactor inlet pipe 15 and then flows out the top of the pipeline reactor 40 directly into line 17 or optionally through the reactor outlet pipe 16 into line 17. The internal diameter of pipe 14 may be the same, larger, or smaller than the internal diameter of the reactor inlet pipe 15. The internal diameter of pipe 17 may be the same, larger, or smaller than the internal diameter of the reactor outlet pipe 16.

The reactor inlet pipe 15 and reactor outlet pipe 16 independently have an internal diameter. Preferably the internal diameter of the reactor inlet pipe 15 is equal to or less than the internal diameter of the in-line reactor 40. Preferably the internal diameter of the reactor outlet pipe 16 is equal to or less than the internal diameter of the in-line reactor 40. The internal diameter of the reactor inlet pipe 15 may be equal to or different from the internal diameter of the reactor outlet pipe 16. In one embodiment, the internal diameter of the reactor inlet pipe 15 is equal to the internal diameter of the reactor outlet pipe 16. In another embodiment, the internal diameter of the reactor inlet pipe 15 may be greater than the internal diameter of the reactor outlet pipe 16. In another embodiment, the internal diameter of the reactor inlet pipe 15 may be less than the internal diameter of the reactor outlet pipe 16. The ratio of inlet reactor pipe 15 internal diameter to in-line reactor 40 internal diameter is 1:1, preferably 1:2, more preferably 1:3, more preferably 1:4, more preferably 1:5, up to a ratio of 1:10. The ratio of outlet reactor pipe 16 internal diameter to in-line reactor 40 internal diameter is 1:1, preferably 1:2, more preferably 1:3, more preferably 1:4, more preferably 1:5, up a ratio of 1:10.

The ratio of pipe 14 internal diameter to in-line reactor 40 internal diameter is 1:1, preferably 1:2, more preferably 1:3, more preferably 1:4, more preferably 1:5, more preferably 1:6, more preferably 1:7, more preferably 1:8, more preferably 1:9, and more preferably a ratio of 1:10.

Preferably, the internal diameter of the pipeline reactor 40 is at least equal to or greater than the internal diameter of the pipe 14 which enters the in-line reactor 40 and equal to or less than 10 times the internal diameter of the pipe 14, preferably equal to or less than 6 times the internal diameter of the pipe 14, preferably equal to or less than 5 times the internal diameter of the pipe 14, preferably equal to or less than 4 times the internal diameter of the pipe 14, preferably equal to or less than 3 times the internal diameter of the pipe 14, and preferably equal to or less than 2 times the internal diameter of the pipe 14.

The pipeline reactor 40 of the present invention is not a separate tank, a stirred reactor, a separation vessel, a batch vessel, a semi-batch vessel, or the like. The pipeline reactor 40 may have various components and configurations, some of which will be described herein below, FIG. 2 to FIG. 4.

The addition stage for the introduction of the PEO into the aqueous solution of oil sands tailings comprises any suitable means for adding the PEO, for example an injector quill, a single or multi-tee injector, an impinging jet mixer, a sparger, a multi-port injector, and the like. The flocculant composition comprising a poly(ethylene oxide) (co)polymer is added as a solid, slurry, or dispersion, preferably an aqueous solution. The addition stage is herein after referred to as in-line addition. The in-line addition of the PEO occurs through line 20 at point Y under conditions which exclude dynamic mixing, in other words, the addition occurs without static or dynamic mixers (i.e., no moving parts such as a rotating impeller to aid mixing) at the point of initial contacting of the two feeds. The PEO injection point can be before or within a static mixer or into the pipeline. In one embodiment, the mixing is facilitated by the presence of one or more in-line static mixer (not shown in the FIGs.) downstream from the injector in the direction of flow from where the PEO is added. In the embodiment where there are more than one static mixer they may vary in diameter, type, and elements in both parallel and series configurations.

Once the flocculant composition comprising a poly(ethylene oxide) (co)polymer is added and begins to mix with the oil sands tailing suspension a viscous, but zero to low yield stress, dough-like mixture is formed. Typically, the dough-like mixture forms within 20 seconds, preferably 15 seconds, more preferably 12 seconds, more preferably 10 seconds, more preferably within 5 seconds. As defined herein, low yield stress means equal to or less than 300 Pa, preferably equal to or less than 200 Pa, more preferably equal to or less than 150 Pa, more preferably equal to or less than 100 Pa, more preferably equal to or less than 65 Pa, more preferably equal to or less than 50 Pa.

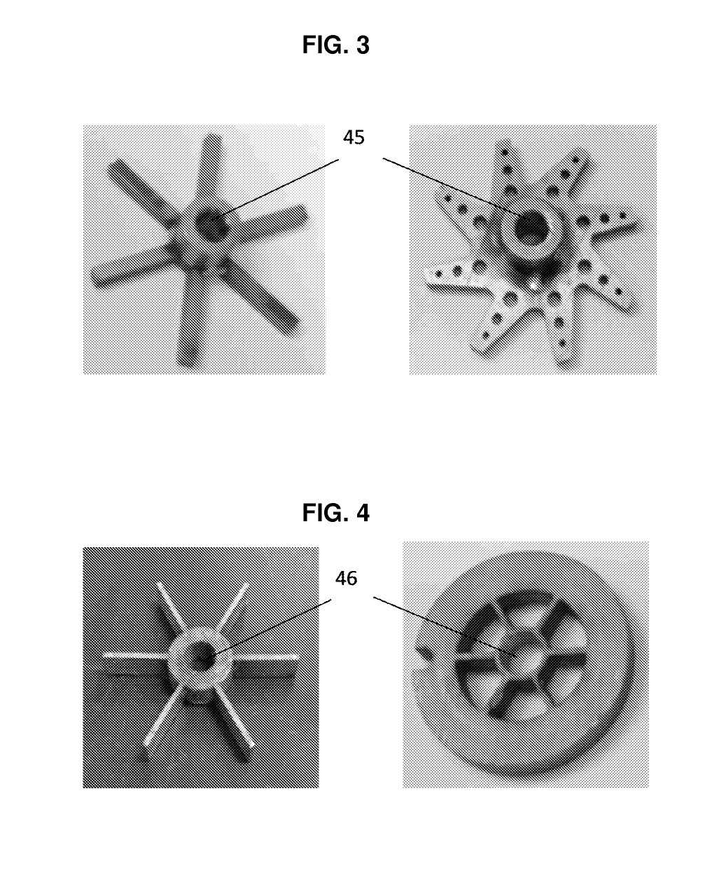

The pipeline reactor 40 comprises one or more rotor 41. A rotor is a rotating impeller designed to provide a tangential component of motion to the fluid. A rotor 41 may consist of simple round pins protruding from a hub 45 (FIG. 3), knife-edge type blades, saw tooth blades such as Morehouse Cowles hi-shear impellers, square pins, or combinations thereof (FIG. 3), or any of a variety of other blade designs suitable for imparting dynamic mixing. One or more different rotor types may be used within different stages of a single in-line dynamic mixer. The first rotor is optimally placed just after the feed entry point into the in-line reactor 40 to provide immediate chopping action as the dough-like mixture enters.

In one embodiment, a stator 42 is placed after a rotor 41, preferably between two rotors 41. A suitable design is as a stationary spoked “hub” of a given depth and is designed to prevent solid body rotation within the pipeline reactor 40. The stator 42 may be held in place by any suitable means, such as a wall baffle or weld. The mixer shaft 44 passes through the stator hub 46 but the stator 42 is not attached to the mixer shaft 44. A stator 42 may consist of simple round pins protruding from a hub (FIG. 2), knife-edge type blades, square pins, or combinations thereof, or any of a variety of other blade design. Further, stator spokes or pins may extend from the hub 46 to the inside wall of the in-line reactor 40 or may be blocked off at the outer radius (FIG. 4). One or more different stator 42 types may be used within different stages of a single in-line dynamic mixer 40.

The in-line reactor 40 of the present invention may have from 1 to 100 rotors 41, preferably from 1 to 75 rotors 41, more preferably from 1 to 50 rotors 41, more preferably from 1 to 40 rotors 41, more preferably from 1 to 30 rotors 41, more preferably from 1 to 25 rotors 41, more preferably from 1 to 20 rotors 41, more preferably from 1 to 15 rotors 41, more preferably from 1 to 10 rotors 41, and more preferably from 1 to 5 rotors 41. Independently from the number of rotors, the in-line reactor 40 of the present invention may have from 1 to 100 stators 42, preferably from 1 to 75 stators 42, more preferably from 1 to 50 stators 42, more preferably from 1 to 40 stators 42, more preferably from 1 to 30 stators 42, more preferably from 1 to 25 stators 42, more preferably from 1 to 20 stators 42, more preferably from 1 to 15 stators 42, more preferably from 1 to 10 stators 42, and more preferably from 1 to 5 stators 42.

A single rotor 41 optionally in combination with a stator 42 is referred to as a “stage”. A stage provides a nominal shear zone between the rotor 41 and stator 42 that imparts a cutting action to the fluid. The pipeline reactor of the process of the present invention comprises a minimum of two or more stages, preferably from 1 to 5 stages, preferably from 1 to 10 stages, preferably from 1 to 15 stages, preferably from 1 to 20 stages 1 to 25 stages, preferably from 1 to 30 stages, preferably from 1 to 40 stages, preferably from 1 to 50 stages, preferably from 1 to 75 stages, preferably from 1 to 100 stages, the number of stages is not limited and as many may be used for a particular operation.

Preferably, there is close clearance between a rotor 41 and a stator 42 in order to provide maximum nominal shear for a given rotational rate. A nominal shear can be defined by the rotor tip speed (π•impeller diameter•impeller rotations per second) divided by the gap 47 between the rotor and the stator. Preferably, the minimum nominal shear rate is equal to or greater than 1000 s⁻¹. The tip speed divided by the gap distance between stator and rotor 47 is used to calculate the nominal shear, or the gap between the impeller tip and wall, or the gap between the impeller tip and wall baffle, if used, whichever gap is least. A suitable gap 47 may be 1 mm, 2 mm, 3 mm, 4 mm, 5 mm, up to 25 mm. The gap 47 between each rotor/stator may be the same or independently different.

It is preferable that no significant bypassing occur in the pipeline reactor, i.e., all fluid elements entering the mixer chamber have a significant probability of entering a high-shear environment. A stator 42 can be installed to be partially blocked off at the outer radius in order to force the fluid towards the center of the mixing chamber, thereby preventing bypassing of some fluid at the walls, FIG. 4 (photograph on right).

The rotors 41 are connected to a mixer shaft 44 which is rotated by a drive 43 to provide shear conditioning to the dough-like mixture of MFT and PEO having zero to low yield stress. Said drive, which is provided at the opposite end from where the dough-like mixture enters the in-line reactor, may be, for example a variable speed motor or constant speed motor. The shear conditioning breaks up the dough-like mixture into microflocs of MFT, thereby allowing the water to flow more readily. However, overshearing may cause the flocs to be irreversibly broken down, resulting in resuspension of the fines in the water thereby preventing water release and drying. The resulting microfloc solution has a viscosity equal to or lower than 1,000 cP and a yield stress equal to or lower than 300 Pa, preferably equal to or less than 40 Pa, more preferably equal to or lower than 30 Pa. Yield stress is conveniently determined with a Brookfield DV3T rheometer.

Not to be held to any particular theory, we believe the nature of the microfloc of the present process reduces the amount of water trapped versus large floc structures as with conventional flocculants, thus the water is more easily released from the solids as they settle and consolidate. Moreover, the process of the present invention produces a continual dewatering system in contrast to the conventional MFT flocculation processes where the water is principally released in the initial few hours after the deposition process. The process of the present invention also avoids conditioning steps taught in conventional flocculation processes. Furthermore, the microfloc is significantly more tolerant of high shear conditions and can be transported and handled with reduced floc breakage/fines generation which reduce dewatering performance. Dewatering is typically determined using gravity settling in graduated cylinders, capillary suction time (CST) measurement, centrifugation followed by measuring the resultant height of solids or a large strain consolidometer. Gravity settling can be performed in a large graduated cylinder where the mud height is captured as a function of time using digital image collection and analysis. The mud height can then be used to calculate percent solids from the initial slurry solid content. Unless otherwise noted, dewatering reported herein is determined by gravity settling in graduated cylinder.

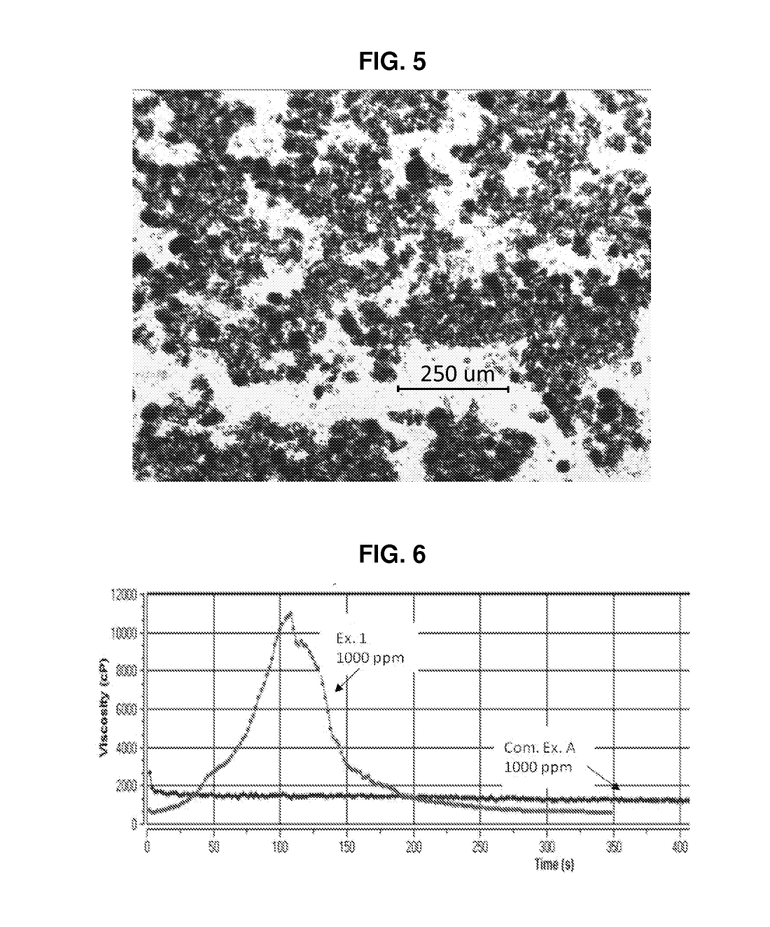

Preferably, the microflocs which result from the dynamic mixing in the process of the present invention have an average size between 10 to 50 microns, FIG. 5. Preferably, the average microfloc size is equal to or greater than 1 micron, more preferably equal to or greater than 5 microns, more preferably equal to or greater than 10 microns, more preferably equal to or greater than 15 microns, even more preferably equal to or greater than 25 microns. Preferably, the average microfloc size is equal to or less than 1000 microns, more preferably equal to or less than 500 microns, more preferably equal to or less than 250 microns, more preferably equal to or less than 100 microns, even more preferably equal to or less than 75 microns. A convenient way to measure microfloc size is from microscopic photos.

After leaving the in-line pipeline reactor 40 the dynamically mixed solution of MFT and PEO comprising floc exits through line 17. Preferably, once the dynamically mixed solution of MFT and PEO leaves the in-line reactor 40 through line 17, it is allowed to build floc, before deposition or further treatment. Line 17 may comprise a static mixer, a small tank, an enlarged diameter section of piping, or a length of pipe with or without bends to create a favorable hydrodynamic environment for the fluid mixture. Preferably this initial mixing or blending step of MFT and PEO is allowed to take place for at least 5 seconds, preferably at least 10 seconds, preferably at least 15 seconds, more preferably at least 20 seconds, more preferably at least 30 seconds, and more preferably at least 45 seconds. The upper time limit for this mixing is whatever is practical for the particular process, but typically, an adequate time is equal to or less than an hour, equal to or less than 30 minutes, more preferably equal to or less than 10 minutes, more preferably equal to or less than 5 minutes more preferably less than 1 minute.

Preferably, in the process of the present invention, there is a concentration of solids to at least 45 weight percent after 20 hours from a starting MFT solution of from 30 to 40 weight percent solids. Preferably there is continued thickening with an increase of solids to 50 weight percent or more over a timeframe of 100 to 1000 hours.

Preferably, the process of the present invention provides a floc having a settling rate for 100 hours or more equal to or greater than 4 weight percent per log 10 hour, preferably equal to or greater than 4.5, preferably equal to or greater than 5, and more preferably equal to or greater than 5.5 weight percent per log 10 hour. Settling rate is defined as the change in solids weight percent of the solids below the mudline over time. From 1 to 100 hours after deposition, this rate of change is approximately linear with the log of settling time.

In one embodiment of the process of the present invention (A) shown in FIG. 1, the flocculated MFT is transported to a thin lift sloped deposition site 50 having a slope of 0.5 percent to 4 percent to allow water drainage. This water drainage allows the material to dry at a more rapid rate and reach trafficability levels sooner. Additional layers can be added and allowed to drain accordingly.

In another embodiment of the process of the present invention (B) shown in FIG. 1, the flocculated MFT is transferred via line 17 to a centrifuge 60. A centrifuge cake solid containing the majority of the fines and a relatively clear centrate having low solids concentrations are formed in the centrifuge 60. The centrifuge cake can then be transported, for example, by trucks, and deposited in a drying cell.

In a further embodiment of the process of the present invention (C) shown in FIG. 1, the flocculated MFT is removed and placed in a thickener 70, said thickener 70 may comprise rakes (not shown in FIG. 1), to produce clarified water and thickened tailings for further disposal.

Yet a further embodiment of the process of the present invention (D) is shown in FIG. 1, the flocculated MFT is deposited at a controlled rate into an accelerated dewatering cell 80, for example a tailings pit, basin, dam, culvert, or pond, or the like which acts as a fluid containment structure. The containment structure may be filled with flocculated MFT continuously or the treated MFT can be deposited in layers of varying thickness. The water released may be removed using pumps (not shown in FIG. 1). The deposit fill rate is such that maximum water is released during or just after deposition. Additional water may be released by the addition of an overburden layer to the deposited and chemically-treated tailings. In this scenario, water release is further facilitated by a process known as rim ditching where perimeter channels around the deposit are dug. Preferably, the deposited particulate mineral material will reach a substantially dry state. In addition the particulate mineral material will typically be suitably consolidated and firm e.g., due to simultaneous settling and dewatering to enable the land to bear significant weight.

In yet a further embodiment of the process of the present invention above, the flow of oil sands tailings treated with the poly(ethylene oxide) (co)polymer is laminar throughout the treatment process and/or is transported to the deposition area in the laminar flow regime.

### EXAMPLES

### Example 1 and Comparative Example A

To 87 grams of a 36 weight percent solids MFT obtained from a tailings pond in northern Alberta, Canada, is added 8 grams of a 0.4 weight percent aqueous solution of poly(ethylene oxide) homopolymer having a weight average molecular weight of 8,000,000 Da and a 1% viscosity of at least 160 cP. The PEO polymer is available as POLYOX WSP 308 poly(ethylene oxide) polymer from The Dow Chemical Company. The MFT and PEO are lightly mixed by pouring back and forth for 5 times between two beakers. Similarly, Comparative Example A, a sample of MFT and partially hydrolyzed polyacrylamide (HPAM) is also prepared. The V-73 vane of a Brookfield DV3T rheometer is inserted into the MFT/PEO mixture and rotated at 50 rpm while the viscosity versus time data was collected. FIG. 6 shows the viscosity versus time data for MFT for Example 1 and Comparative Example A. The viscosity of Comparative Example A remains fairly constant at around 1350 cP, as the vane is rotated. In comparison, the viscosity of Example 1 is initially around 700 cP, however, upon mixing, it forms a dough-like mixture having a viscosity of greater than 10000 cP. As mixing is continued, the dough-like mixture is broken up and the viscosity begins to noticeably decrease.

### Examples 2 to 7

To a 41.5 weight percent solids MFT obtained from a tailing pond in northern Alberta, Canada, pumped through a 1 inch pipe is added a 0.4 weight percent aqueous solution of poly(ethylene oxide) homopolymer having a weight average molecular weight of 8,000,000 Da and 1% viscosity of at least 160 cP. The polymer is available as POLYOX WSP 308 poly(ethylene oxide) polymer from The Dow Chemical Company. The mixture of MFT and polymer is pumped through the system at a flow rate of 2 gpm. After the PEO and MFT streams are combined, a dough-like mixture is formed having a viscosity of greater than 10,000 cP. The mixture is introduced into an 11 stage (each stage is comprised of a rotor/stator pair) in-line reactor to provide dynamic mixing having an internal diameter of 2 inches. The inlet and outlet piping to the dynamic mixer are both 0.824 inches. The 11 rotors within the in-line reactor are 6 pin impellers which rotate at a speed of 2300 rpm. The dough-like mixture is broken up to form a flocculated oil sands tailings made up of microflocs having sizes generally from 1 micron to 500 microns. The flocculated oil sands tailings exit the in-line reactor and flow directly into 2 L graduated cylinders and are allowed to settle. A portion of the flocculated oil sands tailings exiting the in-line reactor is also collected in a 16 oz glass jar, and the yield stress of the sample is measured with a Brookfield DV3T rheometer using a V-73 vane rotating at 0.2 rpm. Examples 2 to 7 are a series of experiments conducted for different PEO dosages ranging from 500 ppm to 1800 ppm, and the solids level and yield stresses of the samples are monitored for each dosage case. Table 1 tabulates the yield stress and 20 hour solid weight percent of the samples for different PEO dosages. The solid weight percentage represents the average of three samples taken at the same conditions. It is seen that although yield stress of the samples decreases from a value of 154 Pa at a PEO dosage level of 1800 ppm (Example 7) to a value of 65 Pa at a PEO dosage level of 500 ppm (Example 2), dewatering is relatively independent (Standard Deviation=0.8) of the dosage level above a minimum amount of chemical treatment necessary for dewatering performance. Thus, dewatering is relatively insensitive to PEO dosage level and rheology of flocculated oil sand tailings.

TABLE 1

| | PEO | Yield | Solid Wt % |
|---|---|---|---|
| Example | Dosage (ppm) | Stress (Pa) | at 20 hrs |
| 2 | 500 | 65 | 45.2 |
| 3 | 800 | 79 | 45.4 |
| 4 | 1100 | 94 | 47.1 |
| 5 | 1200 | 109 | 46.3 |
| 6 | 1500 | 138 | 47.4 |
| 7 | 1800 | 154 | 46.8 |

### Examples 8 to 10

To a 41.5 weight percent solids MFT obtained from a tailing pond in northern Alberta, Canada, pumped through a 1 inch pipe is added a 0.4 weight percent aqueous solution of poly (ethylene oxide) homopolymer having a weight average molecular weight of 8,000,000 Da and 1% viscosity of at least 160 cP. The PEO polymer is available as POLYOX WSP 308 poly(ethylene oxide) polymer from The Dow Chemical Company. The mixture is pumped through the system at a flow rate of 2 gpm. After the PEO and MFT streams are combined, a dough-like mixture is formed having a viscosity of greater than 10,000 cP. The mixture is introduced into an 11 stage (each stage is comprised of a rotor/stator pair) in-line reactor to provide dynamic mixing having an internal diameter of 2 inches. The inlet and outlet piping to the dynamic mixer are both 0.824 inches. The 11 rotors in the in-line reactor are 6 pin impellers which rotate at a set speed. The dough-like mixture is broken up to form a flocculated oil sands tailings made up of microflocs having sizes generally from 1 micron to 500 microns. Three experiments are conducted. In Example 8, the in-line reactor runs at 1600 rpm and the flocculated oil sands tailings exit the in-line reactor and enter a 4 element 4 inch diameter SMX static mixer. The fluid mixture exits the 4 inch static mixer and flows directly into a graduated cylinder and is allowed to settle. In Example 9, the reactor runs at 1600 rpm and the flocculated oil sands tailings exits the in-line reactor and is split into two equal streams. Each stream passes through a 4 element 4 inch diameter SMX static mixer. The fluid mixture exits the two parallel 4 inch static mixers and combines into a single stream and finally flows directly into a graduated cylinder, where it is allowed to settle. In Example 10, the in-line reactor runs at 2300 rpm and the flocculated oil sands tailings exit the in-line reactor and flow directly into a graduated cylinder and is allowed to settle. The solids level, in milliliters (ml), is recorded versus time in minutes (min) for the three experiments. Furthermore, a portion of the flocculated oil sands tailings from each experiment is collected in three 16 oz glass jars, and the yield stresses of the three samples are measured with a Brookfield DV3T rheometer using a V-73 vane rotating at 0.2 rpm. Table 2 summarizes the yield stress and 18 hour solid weight percent of the three samples. It is seen that for Examples 8 and 9 with the static mixers, the samples have yield stresses of over 200 Pa, whereas for Example 10, without the static mixer, the yield stress of the sample is only 121 Pa. However, dewatering of the three samples is within 1.7% of each other. Thus dewatering is relatively independent (Standard Deviation=1.2) of the rheology of the flocculated oil sands tailings.

To a 41.5 weight percent solids MFT obtained from a tailing pond in northern Alberta, Canada, pumped through a 1 inch pipe is added a 0.4 weight percent aqueous solution of poly(ethylene oxide) homopolymer having a weight average molecular weight of 8,000,000 Da and 1% viscosity of at least 160 cP. The PEO polymer is available as POLYOX WSP 308 poly(ethylene oxide) polymer from The Dow Chemical Company. The mixture is pumped through the system at a flow rate of 2 gpm. After the PEO and MFT

TABLE 2

| | In-Line | | | |
|---|---|---|---|---|
| | Reactor | | | |
| | Rotational | | Yield | |
| | Speed | Static Mixer Downstream | Stress | Solid Wt % |
| Example | (rpm) | of the In-Line Reactor | (Pa) | at 18 Hours |
| 8 | 1600 | 4 element 4 inch diameter | 260 | 47.9 |
| | | SMX static mixer | | |
| 9 | 1600 | Two 4 element 4 inch | 203 | 48.4 |
| | | diameter SMX static mixers | | |
| | | in parallel | | |
| 10 | 2300 | None | 121 | 46.1 |

### Examples 11 to 14

streams are combined a dough-like mixture is formed having a viscosity of greater than 10,000 cP. The mixture is introduced into an 11 stage (each stage is comprised of a rotor/stator pair) in-line reactor to provide dynamic mixing having an internal diameter of 2 inches. The inlet and outlet piping to the dynamic mixer are both 0.824 inches. The 11 rotors in the in-line reactor are 6 pin impellers which rotate at a set speed. The dough-like mixture is broken up to form a flocculated oil sands tailings made up of microflocs having sizes generally from 1 micron to 500 microns. The flocculated oil sands tailings exit the in-line reactor and flow directly into a graduated cylinder and is allowed to settle. Four experiments are performed. For Examples 11 to 14, respectively, the in-line reactor runs at 1600 rpm, 2300 rpm, 2800 rpm, and 3300 rpm. The solids level, in milliliters (ml) is recorded versus time in minutes (min) for the four experiments. A portion of the flocculated oil sands tailings from the four experiments exiting the in-line reactor is also collected in four 16 oz glass jars, and the yield stresses of the four samples are measured with a Brookfield DV3T rheometer using a V-73 vane rotating at 0.2 rpm. Table 3 summarizes the yield stress and 22 hour solid weight percent of the four samples. It is seen that yield stress of the samples decreases from a value of 170 Pa at an in-line reactor speed of 1600 rpm to a value of 127 Pa at an in-line reactor speed of 3300 rpm. The dewatering is low at the in-line reactor speed of 1600 rpm. However, dewatering is relatively independent (Standard Deviation=0.7) of the in-line reactor speed between 2300 and 3300 rpm. Thus, a minimum critical speed is necessary for good dewatering. At in-line reactor speeds higher than the minimum critical speed, dewatering is relatively insensitive to in-line reactor speed and rheology of flocculated oil sand tailings.

TABLE 3

| | In-Line Reactor | Yield | Solid Wt % |
|---|---|---|---|
| Example | Speed (rpm) | Stress (Pa) | at 22 hrs |
| 11 | 1600 | 170 | 42.8 |
| 12 | 2300 | 158 | 47.0 |
| 13 | 2800 | 142 | 45.5 |
| 14 | 3300 | 127 | 46.8 |

### Examples 15 to 17

To a 41.5 weight percent solids MFT obtained from a tailing pond in northern Alberta, Canada, pumped through a 1 inch pipe is added a 0.4 weight percent aqueous solution of poly(ethylene oxide) homopolymer having a weight average molecular weight of 8,000,000 Da and 1% viscosity of at least 160 cP. The PEO polymer is available as POLYOX WSP 308 poly(ethylene oxide) polymer from The Dow Chemical Company. The mixture is pumped through the system at a flow rate of 1.5 gpm. After the PEO and MFT streams are combined, a dough-like mixture is formed having a viscosity of greater than 10,000 cP. The mixture is introduced into an 11 stage (each stage is comprised of a rotor/stator pair) in-line reactor to provide dynamic mixing having an internal diameter of 2 inches. The inlet and outlet piping to the dynamic mixer are both 0.824 inches. The 11 rotors in the in-line reactor are 6 pin impellers which rotate at 2300 rpm. The dough-like mixture is broken up to form a flocculated oil sands tailings made up of microflocs having sizes generally from 1 micron to 500 microns. The flocculated oil sands tailings exit the in-line reactor and flow through 150 feet of 1 inch flexible hosing which includes sample ports at 50 feet, 100 feet, and 150 feet downstream of the in-line reactor. Three experiments are performed at each sample port. In Example 15, the sample port on the flexible hosing at a distance of 150 feet downstream of the in-line reactor is opened, and the flocculated oil sands flow directly into a graduated cylinder and are allowed to settle. In Example 16, the sample port on the flexible hosing at a distance of 100 feet downstream of the 2s in-line reactor is opened, and the flocculated oil sands flow directly into graduated cylinders and are allowed to settle. In Example 17, the sample port on the flexible hosing at a distance of 50 feet downstream of the in-line reactor is opened, and the flocculated oil sands flow directly into a graduated cylinder and are allowed to settle. The solids level, in milliliters (ml), is recorded versus time in minutes (min) for the three experiments. A portion of the flocculated oil sands tailings from the three experiments exiting the sample ports is also collected in three 16 oz glass jars, and the yield stresses of the three samples are measured with a Brookfield DV3T rheometer using a V-73 vane rotating at 0.2 rpm. Table 4 summarizes the yield stress and 30 hour solid weight percent of the three samples. It is seen that yield stress of the sample collected from the sample port placed on the flexible hosing at a distance of 50 feet from the in-line reactor is 35 Pa (Example 17), whereas it decreases to 8 Pa when it is collected from the sample port on the flexible hosing placed at distance of 150 feet from the in-line reactor (Example 15). The dewatering is insensitive to overshear in the flexible hosing and rheology of flocculated oil sand tailings.

TABLE 4

| | Distance between the | | |
|---|---|---|---|
| | in-line reactor and the sample port | Yield | Solid Wt % |
| Example | on the flexible hosing (feet) | Stress (Pa) | at 30 hrs |
| 15 | 150 | 8 | 47.8 |
| 16 | 100 | 27 | 47.1 |
| 17 | 50 | 35 | 46.2 |

### Example 18

To a 32 weight percent solids MFT, obtained from a tailing pond in northern Alberta, Canada, pumped through a 1 inch pipe is added a 0.4 weight percent aqueous solution of a poly(ethylene oxide) homopolymer having a weight average molecular weight of 8,000,000 Da and a viscosity of at least 160 cP available. The PEO polymer is available as POLYOX WSP 308 poly(ethylene oxide) from The Dow Chemical Company. The combined flow is pumped through the system at a rate of 1.75 gallons per minute (gpm). After the PEO (dosed at 1,900 g/ton of dry solids) and MFT streams are combined a dough-like mixture is formed having a viscosity of greater than 10,000 cP. The dough-like mixture is introduced into a 2 stage in-line reactor to provide dynamic mixing. This in-line reactor has an internal diameter of 2 inches and comprises three rotating 6 pin rotors and 3 flat blade stators, arranged in an alternating configuration: rotor, stator, rotor, stator, rotor, and stator. The rotors are rotated at a speed of 1500 rotations per minute (rpm). The dough-like mixture is broken up to form flocculated oil sands tailings made up of microflocs having sizes generally from 1 micron to 500 microns. The flocculated oil sands tailings exit the in-line reactor and enter a series of eleven KOMAX™ static mixers. Each static mixer unit has 12 mixer elements and has an internal diameter of 0.75 inch. The mixture exits the static mixer series and flows directly into a graduated cylinder and is allowed to settle. The solids level, in milliliters (ml), is recorded versus time in minutes (min).

Table 5 provides the settling data for the resulting mixture. Although the majority of the dewatering occurs in the first 3 hours, additional dewatering continues past 40 hours.

TABLE 5

| Example 18 | Time (min) | Mud Height (ml) | Solid Wt % |
|---|---|---|---|
| | 0 | 1545 | 26.7 |
| | 141 | 920 | 40.6 |
| | 201 | 905 | 41.2 |
| | 1111 | 860 | 42.8 |
| | 1461 | 850 | 43.2 |
| | 2556 | 840 | 43.6 |

### Example 19

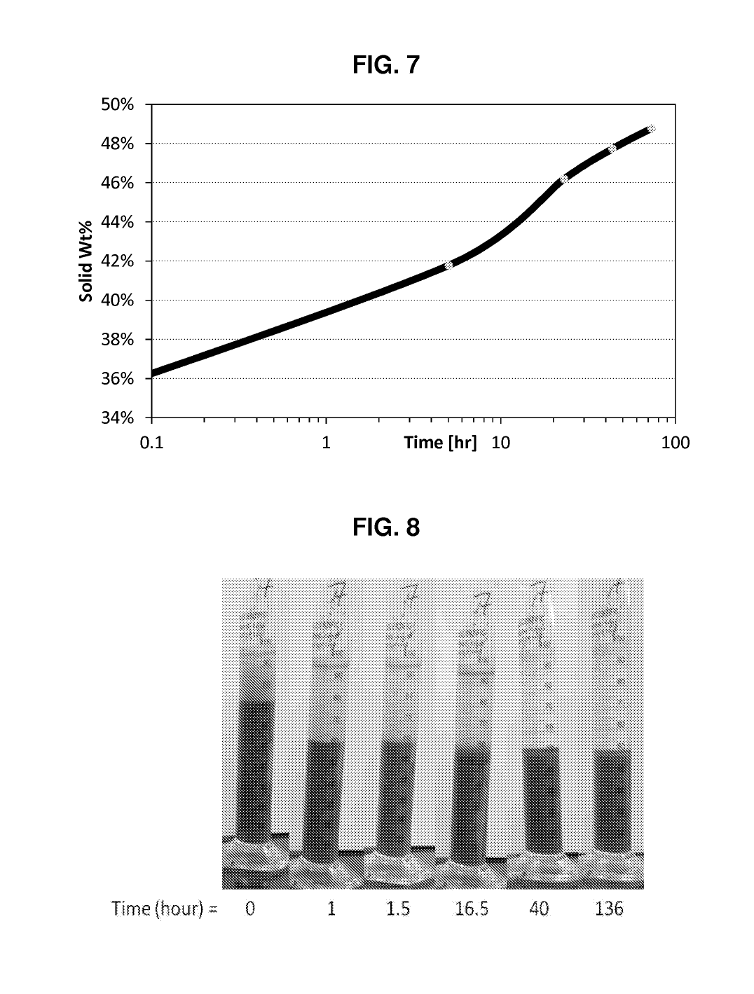

To a 36 weight percent solids MFT obtained from a tailing pond in northern Alberta, Canada, pumped through a 1 inch pipe is added a 0.4 weight percent aqueous solution of poly (ethylene oxide) homopolymer having a weight average molecular weight of 8,000,000 Da and 1% viscosity of at least 160 cP. The PEO polymer is available as POLYOX WSP 308 poly(ethylene oxide) from The Dow Chemical Company. The mixture is pumped through the system at a flow rate of 1.85 gpm. After the PEO and MFT streams are combined a dough-like mixture is formed having a viscosity of greater than 10,000 cP. The dough-like mixture is introduced into a 13 stage (each stage comprising alternating rotors/stators) in-line reactor to provide dynamic mixing having an internal diameter of 2 inches. The inlet and outlet piping to the dynamic mixer are both 0.824 inches. The 13 rotors in the in-line reactor are 6 pin impellers which rotate at a speed of 1700 rpm. The dough-like mixture is broken up to form a flocculated oil sands tailings made up of microflocs having sizes generally from 1 micron to 500 microns. The flocculated oil sands tailings exit the in-line reactor and enter a 12 element 3 inch diameter SMX static mixer. The fluid mixture exits the 3 inch static mixer and is pumped through 30 feet of 0.75 inch flexible hosing into a 30 gallon tank. The settling curve for the resulting mixture is determined by visually observing the settling of the solid-water interface commonly called the mudline and is shown in FIG. 7.

### Examples 20 to 22

For Examples 20 to 22, a thickened tailings (TT) sample having 45.2% solids by mass with a density of 1.39 mg/L is evaluated. The TT sample has around 0.6 mass % bitumen and a clay content of 3 wt% which corresponds to a low Methylene Blue Index (MBI) of 3 meq/100 g. The mean particle size measured by light scattering is 13.5 μm.

Flocculant polymer solutions are made by adding a poly(ethylene oxide) homopolymer having a weight average molecular weight of 8,000,000 Da and 1% viscosity of 10,000-15,000 cP to DI water (no process water included with the TT sample) to obtain a 0.4 wt% solution by mass. The PEO polymer is UCARFLOCTM 309 (UCAR), which is available from The Dow Chemical Company. The dry polymer powder is slurried in a minimal amount of isopropanol, to which the required volume of water is added with brisk stirring from an overhead impeller. After 5 minutes, the polymer is well dispersed in the water and the stirrer speed was reduced to approximately 100 rpm, and the solution is stirred further for 1 hour. The solution then remained static for an additional hour before use.

A 1 L sample of TT is placed in a 1 L beaker and stirred at 150 rpm with a two-blade overhead impeller. This generated a high rate of mixing for the TT and yielded a homogenous, low yield stress material for subsampling and testing.

An 80 mL sample of TT is removed and poured into an in-line mixing flow loop with static mixer elements. The TT sample is circulated through the loop for 30 seconds at a 200 rpm pump speed (65 cm/s tubing velocity) before the required volume of flocculant solution is injected via a syringe pump over 80 seconds to generate the required dose of polymer: Example 20 is 1000 ppm, Example 21 is 1500 ppm, and Example 22 is 2000 ppm. The mixing loop continued to circulate the sample at 200 rpm pump speed during the injection. After injection of the flocculant, the sample is recirculated through the mixing loop for 80 additional seconds before stopping the flow. This yielded a total number of mixer element passes of roughly 200 (varies slightly based on amount of flocculant solution added/dosage). The sample of treated TT was then pumped out of the loop and into a 100 mL graduated cylinder.

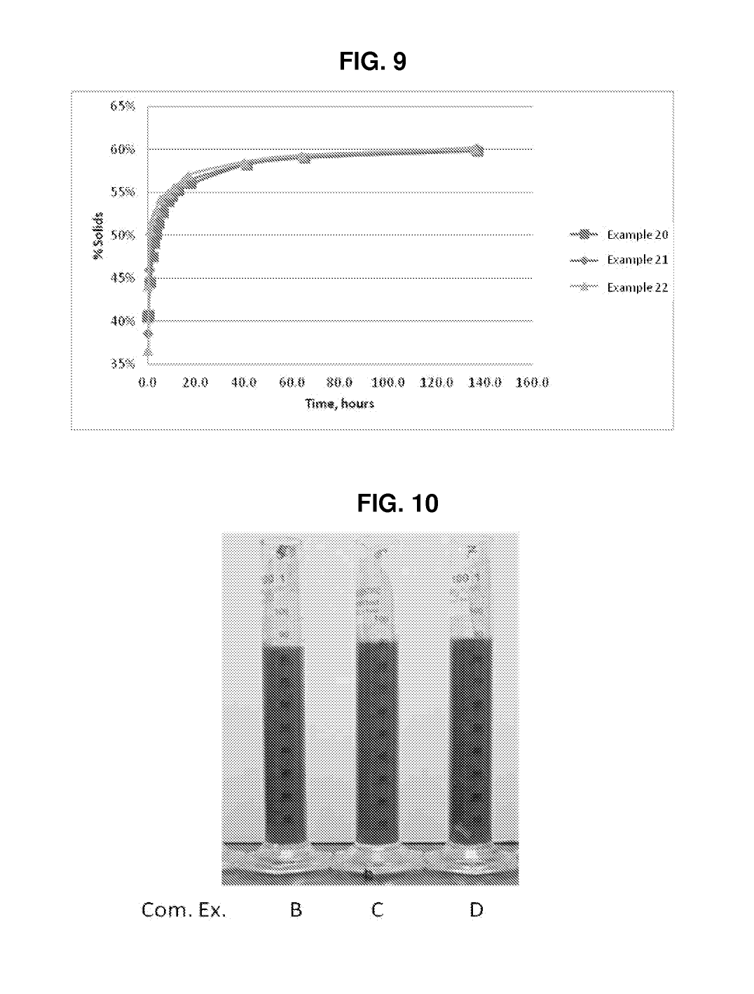

The total sample level is indicated on the graduated cylinder and is recorded. The settled solids level is then monitored and recorded over time. Every morning the free water is removed. The solids content and density of this separated water is measured. The average solids content of the settled solids could then be calculated based on the density of the removed water, initial density of the TT, the total sample volume in the graduated cylinder, and the settled solids volume. FIG. 8 shows the settling for Example 22 versus time. The settling curves representing average solids weight percent of settled solids from the TT sample for Examples 20 to 22 are shown in FIG. 9.

At the conclusion of the study (7 days), a sample of the settled solids is removed and measured for final average solids content. The result is recorded and cross-referenced with the calculated value. In all cases, the calculated value is confirmed by the experimental result. The settled solids are then measured using a Brookfield viscometer for yield stress and viscosity (instrument parameters listed below with results).

Table 6 summarizes the average solids content in the released water, density, yield stress, and viscosity of the three samples. The viscosity is measured on a Brookfield LVDV-E viscometer using an LV4 spindle at 20 rpm and 25° C. An error of +/−10% is expected.

TABLE 6

| | Solids | | Yield | |
|---|---|---|---|---|
| Example | content (%) | Density (g/mL) | Stress (Pa) | Viscosity (cP) |
| 20 | 1.2 | 1.0074 | >37 | 16600 |
| 21 | 1 | 1.0041 | >37 | 22500 |
| 22 | 0.8 | 1.0017 | >37 | 19800 |

### Comparative Examples B to D

As a comparison, a sample of TT is treated with 500, 750 and 1000 ppm HPAM, Comparative Examples B, C, and D, respectively. Several mixing conditions are utilized to attempt to maximize performance. However, no conditions or dosage levels resulted in any observed settling or dewatering after six days (FIG. 10).

What is claimed is:

1. A process for flocculating and dewatering oil sands fine tailings, comprising the steps:
i providing an in-line flow of an aqueous suspension of oil sands fine tailings through a pipe, said pipe having an internal diameter,
ii introducing a flocculant composition comprising a poly(ethylene oxide) (co)polymer into the aqueous suspension of oil sands fine tailings,
iii mixing the flocculant composition and the aqueous suspension of oil sands fine tailings without static or dynamic mixers for a period of time sufficient to form a dough-like material,
iv introducing the dough-like material into an in-line reactor through the pipe wherein the internal diameter of the in-line reactor is equal to or less than five times the internal diameter of the pipe,
v subjecting the dough-like material to dynamic mixing within the in-line reactor for a period of time sufficient to break down the dough-like material to form microflocs, wherein the resulting flocculated oil sands tailings has a viscosity equal to or less than 1,000 cP and a yield stress of equal to or less than 300 Pa, and said microflocs have an average size of from 1 to 500 microns,
vi flowing the flocculated oil sands fine tailings from the in-line reactor through a pipe or one or more static mixer or a combination of piping and one or more static mixer and
vii further treating or depositing the flocculated oil sands fine tailings.

2. The process of claim 1 further comprising the step:
viii adding the flocculated oil sands fine tailings to at least one centrifuge to dewater the flocculated oil sands fine tailings and form a high solids cake and a low solids centrate.

3. The process of claim 1 further comprising the step:
viii adding the flocculated oil sands fine tailings to a thickener to dewater the flocculated oil sands fine tailings and produce thickened oil sands fine tailings and clarified water.

1. cess of claim 1 further comprising the step:
viii adding the flocculated oil sands fine tailings to at least one deposition cell such as an accelerated dewatering cell for dewatering.

5. The process of claim 1 further comprising the step:
viii spreading the flocculated oil sands fine tailings as a thin layer onto a sloped deposition site.

6. The process of claim 1 wherein the poly(ethylene oxide) (co)polymer composition comprises a poly(ethylene oxide) homopolymer, a poly(ethylene oxide) copolymer, or mixtures thereof.

7. The process of claim 6 wherein the poly(ethylene oxide) copolymer is a copolymer of ethylene oxide with one or more of epichlorohydrin, propylene oxide, butylene oxide, styrene oxide, an epoxy functionalized hydrophobic monomer, glycidyl ether functionalized hydrophobic monomer, a silane-functionalized glycidyl ether monomer, or a siloxane-functionalized glycidyl ether monomer.

8. The process of claim 1 wherein the poly(ethylene oxide) (co)polymer has a molecular weight of equal to or greater than 1,000,000 Da.

9. The process of claim 1 wherein the flow of tailings treated with poly(ethylene oxide) (co)polymer is laminar throughout the treatment process and/or is transported to the deposition area in the laminar flow regime.

10. The process of claim 1 where the oil sands fine tailings are mature fines tailings (MFT).

11. The process of claim 1 where the oil sands fine tailings are thickened tailings (TT).
